(19) United States
(12) Patent Application Publication
(10) Pub. No.: US 2017/0251431 A1
(43) Pub. Date: Aug. 31, 2017

(54) Power Management of High-Bandwidth Wireless Mesh Network

(71) Applicant: Newtrax Holdings Inc., Montreal (CA)

(72) Inventors: Serge Croteau, Laval (CA); Alexandre Cervinka, Verdun (CA)

(21) Appl. No.: 15/516,646

(22) PCT Filed: Oct. 5, 2015
(86) PCT No.: PCT/CA2015/051007

§ 371 Date: Apr. 3, 2017

Related U.S. Application Data
(60) Provisional application No. 62/059,286, filed on Oct. 3, 2014.

(51) Int. Cl. H04W 52/02

(52) U.S. Cl. CPC H04W 52/0216; H04W 52/0229; H04W 84/18

(57) ABSTRACT

There is provided a power management method to extend the battery life of wireless routers being parts of Wi-Fi or other high-bandwidth wireless mesh networks. The method comprises the steps of connecting the clients, such as smart phones or computers, on a constant, low-bandwidth connection, using the low-bandwidth protocol/network of the routers, and to activate the high-bandwidth protocol of the router, thus providing a high-bandwidth connection to clients, only when either a request is sent by the client, or the file to transfer has a size to important to be supported by the low-bandwidth connection. There is also provided a method to minimize the power consumption of a mesh of wireless routers by activating the high-bandwidth protocol to only the routers that are located on the shortest route between the main router and the client.

### CROSS-REFERENCE TO RELATED APPLICATIONS

The present patent application claims the benefits of priority of U.S. Patent Application No. 62/059,286, entitled “Power management of high-bandwidth wireless mesh network” and filed at the United States Patent and Trademark Office on Oct. 3, 2014.

### FIELD OF THE INVENTION

The present invention generally relates to the field of wireless telecommunication networks. The invention more particularly concerns power management of battery-powered or autonomous high-bandwidth wireless mesh network.

### BACKGROUND OF THE INVENTION

Wireless mesh network technologies like Dust Networks, Zigbee or DASH7 (hereinafter referred to as “WS Networks”) are typically optimized for static multi-hop wireless sensor network topologies. Their bandwidth is generally limited to speeds in the order of kilo-bauds per second (kbps). Such networks consume very low level of power as a typical wireless routers may last YEARS on a D-size battery or similar battery. Such wireless mesh networks are thus desirable in environment where using wired networks is impossible or difficult, such as underground mines or in tunnels.

To the opposite, a Wi-Fi or other high-bandwidth wireless mesh network (hereinafter referred to as “WHB Networks”) offers a bandwidth typically measured in Mbps. However, the typical wireless routers used in such high bandwidth networks last at most a few HOURS on a D-size battery or similar battery.

Other networks, such as Fiber Ethernet Network (hereinafter referred to as “Fiber Networks”), offer bandwidth typically measured in Mbps or Gbps. Switches and/pr routers used in such Fiber Networks generally last at most a few HOURS on a D-size battery or similar battery.

WS Networks are based on ultra-low power integrated circuits that have a deep sleep mode in the uA and can wake up and return to deep sleep mode very quickly, typically in a few ms.

For example, a device based on this type of ultra-low power integrated circuit could have a duty cycle of less than 1% with a time-average power consumption of 10 uW, despite executing a basic low-bandwidth networking function 10 times per second:
1—Sleep for 97 ms consuming 3 uW;
2—Wake up in 1 ms consuming 1,000 uW;
3—Execute the networking function for 1 ms consuming 3,000 mW; and
4—Return to sleep in 1 ms consuming 1,000 uW.

By contrast, the integrated circuits used in WHB Networks have a deep sleep mode which is several orders of magnitude less power efficient, typically consuming more than 5,000 uW (1 mA @ 5V), and the wake up process is also several orders of magnitude longer, typically several seconds, making it ill-suited for the high-frequency duty-cycling required to be “always on” or “always live” while combining a low effective duty cycle.

For example, a device based on this other type of integrated circuit used to execute the same low-bandwidth networking function would typically behaves as follows:
1—Sleep for about 97 ms consuming about 5,000 uW;
2—Wake up in about 3,000 ms consuming about 50,000 uW;
3—Execute the networking function in about 1 ms consuming about 500,000 uW;

Return to sleep in about 3,000 ms consuming about 50,000 uW.

For this specific example, the net result would be power consumption 50,000+higher to execute the same low bandwidth networking function with WHB Networks electronics vs. WS Networks electronics. A difference of several orders of magnitude is the norm.

The key invention in the Newtrax Canadian patent 2,676,046, which applies to the realm of WS Networks, is a method to accelerate the ad hoc network discovery and synchronization of rapidly moving mobile terminals, without significantly affecting the battery life of the static wireless routers forming the network infrastructure, by inversing the traditional paradigm of wireless telecommunication systems, which traditionally minimizes power consumption in the mobile battery-powered terminals (cell phones, RFID tags) at the expense of higher power consumption in the fixed based stations (cell towers, RFID tag readers), which are assumed to be line-powered by the grid.

### SUMMARY OF THE INVENTION

One of the objects of the present invention is to aim at providing a constant access to a low-bandwidth wireless network and at providing a high-bandwidth connection whenever required by clients, such as, but not limited to, computers.

The aforesaid and other objectives of the present invention are realized by generally providing a wireless switching device configured to connect to a low-bandwidth network and to a high-bandwidth network and to activate the high-bandwidth network on demand only to reduce power consumption.

The invention is also directed to a method to reduce power consumption of a network using at least one wireless switching device, the wireless switching device being connected to a low-bandwidth network and to a high-bandwidth network, the wireless switching device being connected to at least one network node and the high-bandwidth network being deactivated. The method comprises the steps of providing a constant wireless connection using the low-bandwidth network between the wireless switching device and the at least one network node, activating the high-bandwidth network upon reception of a request of activation to the wireless switching device from one of the at least one network node, and triggering the deactivation of the high-bandwidth network.

In one aspect of the invention, the deactivation of the high-bandwidth network is triggered when at least one predetermined condition is met. The predetermined condition preferably occurs when a predetermined time limit elapses or when no data is exchanged on the high-bandwidth network during a predetermined duration.

In another aspect of the invention, the method may be used in a network composed of two or more wireless switching devices.

In another aspect of the invention, the method further comprises propagating the request of activation of the high-bandwidth network from a wireless switching device to at least one other wireless switching device using the low-bandwidth network.

According to yet another aspect of the invention, the method to reduce power consumption further comprises propagating the triggering of deactivation of the high-bandwidth network from a wireless switching device to at least one other wireless switching device using the low-bandwidth network.

In another aspect of the invention, the request of activation of the high-bandwidth comprises a destination network node and the propagation of the said request is limited to wireless switching devices required to communicate with the destination network node.

In another aspect of the invention, an activation device is connected to the low-bandwidth network, the method further comprising using the activation device to send the request to activate the high-bandwidth network to the wireless switching device using the low-bandwidth network.

In another aspect of the invention, the method further comprises using the activation device to trigger the deactivation of the high-bandwidth network through the wireless switching device using the low-bandwidth network.

According to another aspect of the invention, the method further comprises powering the wireless switching device using an autonomous power source, preferably a battery.

According to another aspect of the invention, a routing table is pre-loaded within the wireless switching device for minimizing the delay to activate the high-bandwidth network.

In one aspect of the invention, a wireless switching device configured to connect to a low-bandwidth network and to a high-bandwidth network is provided. The wireless switching device comprises at least one autonomous power source, at least one low-bandwidth network routing device being configured to be turned on most of the time, at least one high-bandwidth routing device and a power control module. The power control module is configured to receive a request from a node connected to the low-bandwidth network for activating the high-bandwidth routing device and to trigger the activation of the high-bandwidth routing device upon reception of the request.

The power control module may further be configured to receive a request from a node connected to the low-bandwidth network for deactivating the high-bandwidth routing device and to trigger the deactivation of the high-bandwidth routing device upon reception of the request.

The power control module may further be configured to manage more at least two concurrent requests for activating or triggering for deactivating the high-bandwidth routing device.

The wireless switching device may further be connected to at least a second wireless switching device. In such an embodiment, the power module of the wireless switching device is configured to propagate the request of activation of the high-bandwidth network to at least the second wireless switching device using the low-bandwidth network.

The power module of the wireless switching device may be further configured to propagate the triggering of deactivation of the high-bandwidth network to at least the second wireless switching device using the low-bandwidth network.

The request of activation of the high-bandwidth may comprise a destination network node and the power module of the wireless switching device may be configured to propagate the said request only to wireless switching devices required to communicate with the destination network node.

The wireless switching device may further be configured to pre-load a routing table of the high-bandwidth network being for minimizing the delay to activate the high-bandwidth network.

The at least one low-bandwidth network routing device, the at least one high-bandwidth network routing device and the power control module and/or autonomous power source may be unitary.

The invention is further directed to Aa network of network nodes comprising at least one wireless switching devices, the at least one wireless switching device being configured to connect to a low-bandwidth network and to a high-bandwidth network,. tThe at least one wireless switching device comprisesing: at least one autonomous power source, at least one low-bandwidth network routing device being configured to be activated most of the time and being connected to at least another, at least one high-bandwidth routing device, a power control module., tThe power control module being configured to, receive a request from a node connected to the low-bandwidth network for activating the high-bandwidth routing device, and trigger the activation of the high-bandwidth routing device upon reception of the request.

The invention is further directed to a network of network nodes comprising at least one wireless switching devices, the at least one wireless switching device being configured to connect to a low-bandwidth network and to a high-bandwidth network. The at least one wireless switching device comprises at least one autonomous power source, at least one low-bandwidth network routing device being configured to be activated most of the time and being connected to at least another, at least one high-bandwidth routing device, a power control module. The power control module being configured to, receive a request from a node connected to the low-bandwidth network for activating the high-bandwidth routing device, and trigger the activation of the high-bandwidth routing device upon reception of the request.

According to another aspect of the invention, the power control module of the at least one wireless switching device is further configured to receive a request from a node connected to the low-bandwidth network for deactivating the high-bandwidth routing device, and trigger the deactivation of the high-bandwidth routing device upon reception of the request.

According to another aspect of the invention, the power control module is further configured to manage more at least two concurrent requests for activating the high-bandwidth routing device. The power control module of the at least one wireless switching device is preferably further configured to manage at least two concurrent triggering for deactivating the high-bandwidth routing device.

According to another aspect of the invention, the at least one wireless switching device is connected to at least one second wireless switching device, the power module of the wireless switching device is configured to propagate the request of activation of the high-bandwidth network to at least one second wireless switching device using the low-bandwidth network. The power module of the at least one wireless switching device is preferably further configured to propagate the triggering of deactivation of the high-bandwidth network to at least one second wireless switching device using the low-bandwidth network.

According to another aspect of the invention, the request of activation of the high-bandwidth comprises a destination network node and the power module of the at least one wireless switching device being configured to propagate the said request only to wireless switching devices required to communicate with the destination network node. The network is preferably a mesh network wherein at least some of the network nodes are mobile terminals.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is an illustrative example of power management method to extend the battery life of wireless routers on WHB or WS Networks technologies.

FIG. 2 is an illustrative example of a wireless switching device in accordance with the present invention.

### DETAILED DESCRIPTION OF THE PREFERRED EMBODIMENT

A novel method of reducing energy consumption in a high-bandwidth wireless network will be described hereinafter. Although the invention is described in terms of specific illustrative embodiments, it is to be understood that the embodiments described herein are by way of example only and that the scope of the invention is not intended to be limited thereby.

A power management method to extend the battery life of wireless routers in WHB Networks and/or switches and routers in Fiber Network in accordance with the principles of the present invention is hereby described. The power management method typically extends the battery life from a number of hours/days to weeks or even months. The method comprises the steps of turning on wireless routers or nodes only when required in order for the wireless router to consume 0 mW or nearly 0 mW when not in use within a WHB Network electronics and/or Fiber Network electronics.

Two types of network topologies are considered:
1. Static network topologies (e.g. for seismic instrumentation monitoring).
2. Fixed network infrastructure comprising mobile terminals, such as but not limited to device used for transferring large files to jumbo drills at the face).

Now referring to FIG. 2, a battery-powered or autonomous wireless switching device 102 used in static network topologies is illustrated. The wireless switching device or router 102 typically comprises at least one energy retainer device or autonomous/external power source 206 such as a battery-pack, a least one low bandwidth WS network routing device or module 202, such as a standard WS Network router, the said WS routing device being configured to be turned on all the time or most of the time. The wireless router device 102 further comprises a standard high-bandwidth or WHB Network routing device or module 204 and/or Fiber Network routing and/or switching device/module and a power control module. The power control module 200 is typically configured to receive and/or process one or more application request via the WS routing device or from an embedded application. The application request may further comprise instruction for turning on/off the WHB Network routing device 204 during a high-bandwidth communication.

In such configuration, the autonomous power source 206 powers the wireless switching device 102. The WS network routing device 202 is connected to the power control module 200. The power control module 200 is at least configured to turn on or turn off the WHB network routing device 204. When the power control module 200 receives instructions or requests from the WS network device 202 or from an application on the WS network 130, the power control module 200 triggers the WHB Network routing device 204 to be turned-on. The WHB network routing device 204 may be connected to the WS network routing device 202 as the request may originate from a device on the WS network 130.

Now referring to fixed network infrastructure comprising mobile terminals topologies, a wireless routing device 102 is configured to communicate with tracking mobile terminals. A wireless routing device 102 typically comprises at least one autonomous power source 20 such as a battery-pack and at least one WS network routing device or module 202, such as a WS Network router, the said at least one WS network routing device 202 being always or nearly always turned on. In a preferred embodiment, such WS network routing device 202 shall preferably be configured to use or be compatible with the technology described in the Canadian patent 2,676,046. Understandably, any other WS routing device being configured to provide low bandwidth using minimal power consumption may be used. The autonomous wireless router 102 further comprises a standard WHB Network routing device or module and/or Fiber Network routing and/or switching device/module and a power control module. The power control module is typically configured to receive and/or process one or more application request via the WS routing device or from an embedded application. The application request may further comprise instruction for turning on/off the WHB Network routing during a high-bandwidth communication.

Now referring to FIG. 2, as in other configurations for static network topologies, the autonomous power source powers the wireless switching device 102. The WS network routing device or low-bandwidth routing module 202 is connected to the power control module 200. When the power control module 200 receives instructions or requests from the WS network routing device 202 or from an application on the WS network, the power control module 200 triggers the WHB Network device or high-bandwidth routing module 204 to be turned-on. The WHB network device 204 may be connected to the WS network routing device 202 as the request may originate from a device on the WS network 130.

The mobile terminals used to communicate with the fixed network infrastructure mentioned above preferably comprise a power source, such as external energy/power supply, a WS mobile terminal module or device for WS Network. In a preferred embodiment, the WS mobile terminal module is configured using the technology described in Canadian patent 2,676,046. Understandably, any other configuration allowing the WS mobile terminal module to provide low bandwidth using minimal power consumption may be used. The mobile terminals further comprise a WHB network mobile terminal module or device.

The power source 206 is configured to provide constant power to the WS network mobile terminal while powering the WHB network mobile terminal module on-demand only.

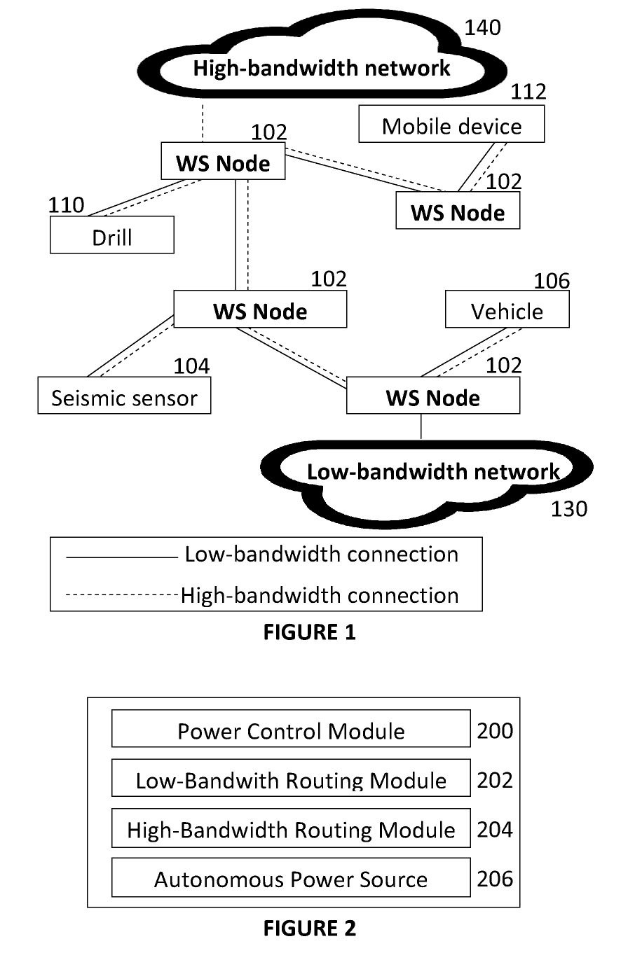

Now referring to FIG. 1, an exemplary a network for seismic instrumentation monitoring in accordance with the present invention is illustrated. A plurality of wireless network switching devices 102, such as but not limited to routers, repeaters or switches are configured as one or more network topology. As an example used for seismic instrumentation monitoring, if one or more of the wireless switching devices 102 were configured to use WHB Networks technology, the battery life of such wireless switching devices 102 would typically last only a few hours but would provide a seismic sensor 104, a vehicle 106, and a mobile device 112 at all time a high-bandwidth communication link of several Mbps.

Still referring to FIG. 1, if wireless switching devices 102 were similarly configured as above but configured to use WS Networks technology, such as but not limited to being configured to use technology such as the one described in Canadian patent 2,676,046, the powered consumption of the device would typically be reduced by several order of magnitude to allow the wireless switching devices 102 to be powered by the same battery packs for years without any need to recharge. However, the seismic sensor 104 and the vehicle 106 would only have access to a low-bandwidth communication link of several kbps.

Since about 99% of the communications involving the seismic sensor 104 and the vehicle 106 are used to send or receive small quantity or size of data, the configuration using a WS Network would be sufficient during about 99% of the period. For the remaining about 1% of the time, the seismic sensor 104 and the vehicle 106 may require sending and/or receiving large files or requiring higher bandwidth for any other purposes. Therefore, when these situations happen, the seismic sensor 104, the vehicle 106, and the mobile device 112 are configured to trigger the turning on of the WHB Network 140 and/or the Fiber Network for a limited or predetermined period of time. Understandably, the present exemplary configuration may be applicable to any other types of nodes and are not limited to a configuration using a seismic sensor 104 and a vehicle 106.

Still referring to the embodiment of FIG. 1, a first wireless switching device 102 is located in a daisy chain 108 and is connected directly to a high-bandwidth communication link, typically a wired backbone network such as Ethernet via a WHB Network electronics and to a gateway for protocol conversion via its WS Network electronics. The autonomous wireless switching devices 102 are configured to use reduced power consumption nearly all the time, thus allowing the autonomous wireless switching devices 102 to be powered using limited power retaining device, such as batteries, for several weeks or months without requiring recharge/replacement and while providing high-bandwidth communication links when required/on-demand

In other embodiments, the request for requiring the turning-on of the WHB Network 140 may be embodied in any node or device connected on the WS network. As an example, a headlamp of a miner connected to the WS network may send a request to the WS routing module of the closest autonomous wireless router to trigger the activation the WHB network 140 when a button located on the lamp is activate. The WHB network routing device 204 is instantly turned on and provides a high-bandwidth network for any device supporting WHB network 140 connection used in the area where is located the miner. Based on the destination address required by the WHB network device, the power module triggers the turning-on of other WHB network routing devices or other WHB network nodes in order to allow a communication between the WHB network device and the destination device to be established. Understandably, any other interface or systems may be used to trigger the activation of the high bandwidth network.

As another example, a server may require to communicate a large file to a drill, both the server and the drill being wirelessly connected on the WS network 130 through an wireless switching device 102. The server sends a request to the wirelessly connected wireless switching device to turn-on the WHB network 140. Upon reception of the request, the power module 206 of the wireless switching device 102 turns on the WHB network routing device 204 of the wireless routing device 102 in communication with the server. The power module 206 or the WS network routing device 204 then send turn-on requests to the different nodes required to establish a WHB network communication link with the drill. Upon instant activation, the server may transfer the large file using high-bandwidth network. Upon completion, the server sends a request to the wireless switching device 102 or to the power control module 200 to turn-off the WHB network 140. The power module 206 requests the turning off of the WHB network router 204. The turning-off request is propagated to all nodes required to establish a communication link between the server and the drill.

According to another embodiment, wherein the WHB network 140 remains active until either the activation device sends another request to shut down the high-bandwidth network 140, or a predetermined shut down condition is met, such as predetermined time limit being elapsed or predetermined period without any data being sent.

In other embodiments, the autonomous wireless routers may be configured to manage different, sequential and/or concurrent requests of turning-on/turning-off actions. As an example, if two devices connected to the autonomous wireless router sequentially requests the turning-on of the WHB network 140, the power control module 200 shall assign a unique identification to each request and shall wait for a turning-off request or for turning-off conditions to be met for each unique identified communication before to turning-off the WHB network routing device 204.

According to another embodiment, wherein the routing table of the WHB network routing device 204 may be pre-cached thus allowing a very short wake-up time. As a example, it may remove or considerably reduce the network discovery phase of the high-bandwidth network and may lower the energy consumption required to start the network since the task of assigning IP addresses to each terminal is not required if no new terminals are added to the network.

According to another embodiment, wherein the mesh network is able to activate the high-bandwidth network in a limited number of routers by finding the shortest path between the main router and the final router that provides the terminal with the low- or high-bandwidth connection. This aspect allows further reduction of power consumption by keeping the remaining routers in dormancy. The efficiency of this characteristic of the present invention is dependant of the topology of the network.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A method to reduce power consumption of a network using at least one wireless switching device, the wireless switching device being connected to a low-bandwidth network and to a high-bandwidth network, the wireless switching device being connected to at least one network node and the high-bandwidth network being deactivated, the method comprising:
providing a constant wireless connection using the low-bandwidth network between the wireless switching device and the at least one network node;
activating the high-bandwidth network upon reception of a request of activation to the wireless switching device from one of the at least one network node;
triggering the deactivation of the high-bandwidth network.

2) The method to reduce power consumption of claim 1, wherein the deactivation of the high-bandwidth network is triggered when at least one predetermined condition is met.

3) The method to reduce power consumption of claim 2, wherein the predetermined condition occurs when a predetermined time limit elapses.

4) The method to reduce power consumption of claim 2, wherein the predetermined condition occurs when no data is exchanged on the high-bandwidth network during a predetermined duration.

5) The method to reduce power consumption of claim 1, wherein the network is composed of two or more wireless switching devices.

6) The method to reduce power consumption of claim 5, wherein the method further comprises propagating the request of activation of the high-bandwidth network from a wireless switching device to at least one other wireless switching device using the low-bandwidth network.

7) The method to reduce power consumption of claim 5, wherein the method further comprises propagating the triggering of deactivation of the high-bandwidth network from a wireless switching device to at least one other wireless switching device using the low-bandwidth network.

8) The method to reduce power consumption of claim 6, wherein the request of activation of the high-bandwidth comprises a destination network node and wherein the propagation of the said request is limited to wireless switching devices required to communicate with the destination network node.

9) The method to reduce power consumption of claim 1, wherein an activation device is connected to the low-bandwidth network, the method further comprising using the activation device to send the request to activate the high-bandwidth network to the wireless switching device using the low-bandwidth network.

10) The method of claim 9, the method further comprising using the activation device to trigger the deactivation of the high-bandwidth network through the wireless switching device using the low-bandwidth network.

11) The method to reduce power consumption of claim 1, the method further comprising powering the wireless switching device using an autonomous power source.

12) The method of claim 11, wherein the autonomous power source is a battery.

13) The method to reduce power consumption of claim 1, wherein a routing table is pre-loaded within the wireless switching device for minimizing the delay to activate the high-bandwidth network.

14) A wireless switching device configured to connect to a low-bandwidth network and to a high-bandwidth network, the wireless switching device comprising:
at least one autonomous power source;
at least one low-bandwidth network routing device being configured to be turned on most of the time;
at least one high-bandwidth routing device;
a power control module, the power control module being configured to:
receive a request from a node connected to the low-bandwidth network for activating the high-bandwidth routing device;
trigger the activation of the high-bandwidth routing device upon reception of the request.

15) The wireless switching device of claim 14, wherein the power control module is further configured to:
receive a request from a node connected to the low-bandwidth network for deactivating the high-bandwidth routing device;
trigger the deactivation of the high-bandwidth routing device upon reception of the request.

16) The wireless switching device of claim 14, wherein the power control module is further configured to manage more at least two concurrent requests for activating the high-bandwidth routing device.

17) The wireless switching device of claim 16, wherein the power control module is further configured to manage more at least two concurrent triggering for deactivating the high-bandwidth routing device.

18) The wireless switching device of claim 14, the wireless switching device being connected to at least a second wireless switching device, the power module of the wireless switching device being configured to propagate the request of activation of the high-bandwidth network to at least the second wireless switching device using the low-bandwidth network.

19) The wireless switching device of claim 18, the power module of the wireless switching device being further configured to propagate the triggering of deactivation of the high-bandwidth network to at least the second wireless switching device using the low-bandwidth network.

20) The wireless switching device of claim 18, the request of activation of the high-bandwidth comprising a destination network node and the power module of the wireless switching device being configured to propagate the said request only to wireless switching devices required to communicate with the destination network node.

21) The wireless switching device of claim 14, wherein the autonomous power source is a battery.

22) The wireless switching device of claim 14, wherein a routing table of the high-bandwidth network is pre-loaded within the wireless switching device for minimizing the delay to activate the high-bandwidth network.

23) The wireless switching device of claim 14, the wireless switching device being configured to pre-load a routing table of the high-bandwidth network topology in memory for minimizing the delay to activate the high-bandwidth network.

24) The wireless switching device of claim 14, wherein the at least one low-bandwidth network routing device, the at least one high-bandwidth network routing device and the power control module are unitary.

25) The wireless switching device of claim 14, wherein the at least one low-bandwidth network routing device, the at least one high-bandwidth network routing device, the power control module and the autonomous power source are unitary.

26) A network of network nodes comprising at least one wireless switching devices, the at least one wireless switching device being configured to connect to a low-bandwidth network and to a high-bandwidth network, the at least one wireless switching device comprising:
at least one autonomous power source;
at least one low-bandwidth network routing device being configured to be activated most of the time and being connected to at least another;
at least one high-bandwidth routing device;
a power control module, the power control module being configured to:
receive a request from a node connected to the low-bandwidth network for activating the high-bandwidth routing device;
trigger the activation of the high-bandwidth routing device upon reception of the request.

27) The network of claim 26, wherein the power control module of the at least one wireless switching device is further configured to:
receive a request from a node connected to the low-bandwidth network for deactivating the high-bandwidth routing device;
trigger the deactivation of the high-bandwidth routing device upon reception of the request.

28) The network of claim 26, wherein the power control module is further configured to manage at least two concurrent requests for activating the high-bandwidth routing device.

29) The network of claim 28, wherein the power control module of the at least one wireless switching device is further configured to manage at least two concurrent triggering for deactivating the high-bandwidth routing device.

30) The network of claim 27, the at least one wireless switching device being connected to at least one second wireless switching device, the power module of the wireless switching device being configured to propagate the request of activation of the high-bandwidth network to at least one second wireless switching device using the low-bandwidth network.

31) The network of claim 30, the power module of the at least one wireless switching device being further configured to propagate the triggering of deactivation of the high-bandwidth network to at least one second wireless switching device using the low-bandwidth network.

32) The network of claim 30, the request of activation of the high-bandwidth comprising a destination network node and the power module of the at least one wireless switching device being configured to propagate the said request only to wireless switching devices required to communicate with the destination network node.

33) The network of claim 26, wherein the network is a mesh network.

34) The network of claim 26, wherein at least some of the network nodes are mobile terminals.
